(19) United States
(12) Patent Application Publication
(10) Pub. No.: US 2025/0256464 A1
(43) Pub. Date: Aug. 14, 2025

(54) METHOD FOR JOINING TWO PARTS BY MEANS OF ELECTRIC RESISTANCE WELDING

(71) Applicant: Airbus Operations GmbH, HAMBURG (DE)

(72) Inventors: Alexei VICHNIAKOV, HAMBURG (DE); Viktor VICHNIAKOV, HAMBURG (DE)

(21) Appl. No.: 19/045,699

(22) Filed: Feb. 5, 2025

(30) Foreign Application Priority Data
Feb. 9, 2024 (EP) 24156929.2

(51) Int. Cl. B29C 65/22; B29C 65/00; B29K 101/12; B29K 309/00

(52) U.S. Cl. CPC B29C 65/22; B29C 66/81871; B29K 2101/12; B29K 2309/00; B29K 2995/0007; B29K 2995/0077

(57) ABSTRACT

A method for joining two parts by means of electric resistance welding including the steps of providing a layer structure for electric resistance welding, the layer structure including: two parts to be joined, wherein at least one of the parts is electrically conductive, an electrically conductive heating component arranged between the two parts, and an electrically insulating component arranged between the heating component and the at least one electrically conductive part, the insulating component comprising one or more basalt fibers, and causing an electric current to flow through the heating component for electric resistance welding of the layer structure along a weld joint surface of the layer structure and thus joining the two parts.

### CROSS-REFERENCES TO RELATED APPLICATIONS

This application claims the benefit of European Patent Application Number 24156929.2 filed on Feb. 9, 2024, the entire disclosures of which are incorporated herein by way of reference.

### FIELD OF THE INVENTION

The invention relates to a method for joining two or more parts by means of electric resistance welding. The invention further relates to an arrangement for joining two or more parts by means of electric resistance welding.

### BACKGROUND OF THE INVENTION

In order to reduce energy or fuel consumption of vehicles, such as aircraft, lightweight construction is more and more a preferred choice. In lightweight construction, heavy parts are replaced, for example, by composites. A composite is a material which is produced from two or more constituent materials. Examples for such material are reinforced plastics, such as fiber-reinforced polymers.

In order to join two or more parts together, welding is a well-known technique. Welding may be achieved, for example, by electric resistance welding. However, welding of composite materials, especially with carbon fibers, may lead to a leakage of current due to the electrical conductivity of the carbon fibers.

### SUMMARY OF THE INVENTION

An object of the invention is to provide an improved method for joining two parts by means of electrical resistance welding.

To achieve this object, the invention provides a method for joining two or more parts by means of electric resistance welding. An arrangement for joining two or more parts by means of electric resistance welding is also provided.

In one aspect, the invention provides a method for joining two or more parts by means of electric resistance welding, the method comprising:
a) providing a layer structure for electric resistance welding, the layer structure including:
   two parts to be joined, wherein at least one of the parts is electrically conductive,
   an electrically conductive heating component arranged between the two parts, and
   an electrically insulating component arranged between the heating component and the at least one electrically conductive part, the insulating component comprising one or more basalt fibers; and
b) causing an electric current to flow through the heating component for electric resistance heating by welding of the layer structure along a weld joint surface of the layer structure and thus joining the two parts.

Preferably, the method further comprises:
c) applying a pressure onto the layer structure orthogonal and/or normal to the weld joint surface during electric resistance welding.

Preferably, the one or more basalt fibers are configured for preventing of current leakages.

Preferably, one, several, or all of the following applies:
d1) Young's modulus of the one or more basalt fibers is above 50 GPa, preferably in the range from 90 to 120 GPa;
d2) the one or more basalt fibers comprise 35-55% w/w SiO₂, preferably 47-50% w/w SiO₂;
d3) the one or more basalt fibers comprise 10-25% w/w Al₂O₃, preferably 15-18% w/w Al₂O₃;
d4) the one or more basalt fibers comprise 3-10% w/w MgO, preferably 5-7% w/w MgO; and/or
d5) the elongation at break of the one or more basalt fibers is in the range from 2 to 5%.

Preferably, the heating component is made of metal and/or has a tensile strength above, i.e., of or more than 0.20 GPa.

Preferably, the insulating component comprises a basalt fiber-based textile, a basalt fiber-based fabric, a basalt fiber-based mesh, a basalt fiber-based mat, and/or a basalt fiber-based fleece.

Preferably, the insulating component comprises a composite, preferably a basalt fiber-reinforced material, more preferably a basalt fiber-reinforced polymer and/or thermoplastic.

Preferably, one or both of the following applies:
e1) the one or more basalt fibers constitute 35-75% vol. of the composite; and/or
e2) the one or more basalt fibers are arranged in parallel in a matrix of the composite.

Preferably, at least one of the parts include a composite, preferably a fiber-reinforced material, more preferably a carbon, glass, basalt, and/or aramid fiber-reinforced material, the material being preferably a polymer and/or thermoplastic.

In another aspect, the invention provides an arrangement for joining two or more parts by means of electric resistance welding, the arrangement comprising a layer structure for electric resistance welding, the layer structure including:
two parts to be joined, wherein at least one of the parts is electrically conductive,
an electrically conductive heating component arranged between the two parts, and
an electrically insulating component arranged between the heating component and the at least one electrically conductive part, the insulating component comprising one or more basalt fibers.

Preferably, the insulating component comprises basalt fiber-based textile, a basalt fiber-based fabric, a basalt fiber-based mesh, a basalt fiber-based mat, and/or a basalt fiber-based fleece.

Preferably, the arrangement further comprises a pressure application device for applying a pressure onto the layer structure orthogonal and/or normal to a weld joint surface.

Preferably, the arrangement further comprises an electric power device electrically connectable to the welding component for electric resistance welding of the layer structure.

Any features or advantages that are described with reference to one aspect of the invention may also be applied to another aspect of the invention.

Embodiments of the invention preferably have the following advantages and effects:

An idea of preferred embodiments of the invention is to provide an improved method for joining two or more parts by means of electrical resistance welding with technology and materials preventing the current leakage during the welding process.

In preferred embodiments of the invention, a “basalt fiber”-based component will be added as an additional layer around the welded composite parts to avoid a current leakage and therefore improve the usage of resistance welding for composite parts.

According to https://www.encyclopedia.com/earth-and-environment/geology-and-oceanography/geology-and-oceanography/basalt basalt is a “dark-colored, fine-grained, extrusive, igneous rock composed of plagioclase feldspar, pyroxene, and magnetite, with or without olivine, and containing not more than 53 wt. % SiO2. Many basalts contain phenocrysts of olivine, plagioclase feldspar and pyroxene. Basalts are divided into two main types, alkali basalts and tholeiites, with the tholeiites being subdivided into olivine tholeiites, tholeiites, and quartz tholeiites. Petrographically (see PETROGRAPHY), alkali basalts have as their groundmass pyroxene titanaugite (an augite rich in titanium), whereas tholeiites have pigeonite (a calcium-poor pyroxene). Also, for similar concentrations of SiO2, alkali basalts have a higher content of Na2O and K2O than tholeiites. Basalt flows cover about 70% of the Earth's surface and huge areas of the terrestrial planets, and are therefore arguably the most important of all crustal rocks. They are formed by partial melting of mantle peridotite. Alkali basalts are typically found on oceanic islands and on the continental crust in regions of crustal upwarping and rifting. Tholeiites are typically found on the ocean floor and on the stable continental crust where they form large basalt plateaus such as the Deccan Traps of India.”

“Basalt fibers” are prepared from natural volcanic rock. Basalt, granite, diabase, amphibolite, diorite, trachyte, porphyry, and/or obsidian may be used as raw material. Herein, the term “basalt fibers” refers in general to volcanic rock-based fibers and in specific to basalt-based fibers, preferably having one, several, or all of the herein described properties.

Basalt fibers may be used in construction industry as thermal insulating material or for reinforcing concrete products. They may be used also in electronics industry for producing circuit boards. However, according to the inventors' knowledge, the usage of basalt fibers for reinforcing laminated materials has not been previously suggested.

The basalt fiber-based component preferably avoids a current leakage and therefore enable the usage of resistance welding for composite parts. This can preferably foster one, several, or all of the following aspects:
improved quality of welding result and potentially increased operating lifetime of parts;
reduced costs of rework due to failed welding processes;
usage of recycled thermoplastic material without additional fastening elements (reduced material variety and weight);
possible usage of bio-based composite materials; and
compatible with existing standard tools for resistance welding, such as a spot-welding gun.

Volcanic rock such as basalt is available at low costs. Furthermore, it advantageously has a broad range of working temperature and a high melting point. Volcanic rock and/or basalt has advantageous insulating properties. Additionally, it is a natural material that can be used for fiber production without further additives. Particularly basalt is a prevalent material and the most abundant volcanic rock on earth.

Basalt fibers advantageously involve a simple production process with reduced energy consumption. Furthermore, basalt fibers have a high chemical resistance and fire resistance. They advantageously have a potential for circular usage (i.e., reusing, recycling, etc.).

### BRIEF DESCRIPTION OF THE DRAWINGS

Embodiments of the invention are now explained in more detail with reference to the accompanying drawings of which

FIG. 1 shows a comparative arrangement for joining two parts by means of electric resistance welding;

FIG. 2 shows an arrangement for joining two parts means of electric resistance welding according to an embodiment of the invention; and

FIGS. 3A-3C show the arrangement according to further embodiments of the invention.

### DETAILED DESCRIPTION OF THE PREFERRED EMBODIMENTS

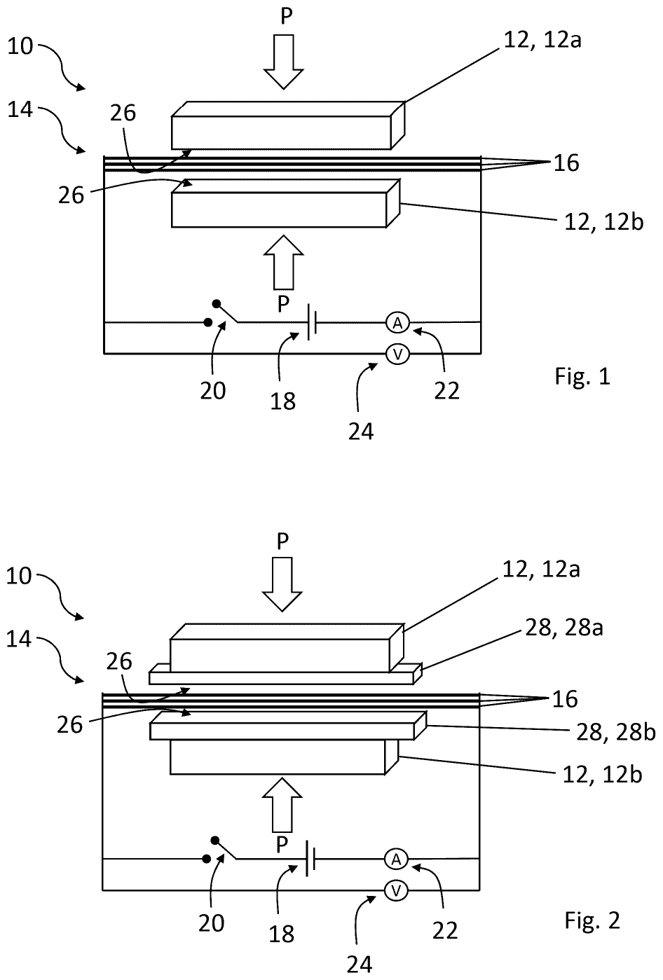

FIG. 1 shows a comparative arrangement 10 for joining two or more parts 12 by means of electric resistance welding.

The comparative arrangement 10 comprises comparative layer structure 14 for electric resistance welding.

The comparative layer structure 14 includes a first part 12a and a second part 12b to be joined. The first part 12a and/or the second part 12b may include a composite, preferably a fiber-reinforced material, more preferably a carbon, glass, basalt, and/or aramid fiber-reinforced material, such as polymer and/or thermoplastic.

The comparative layer structure 14 further includes an electrically conductive heating component 16 that is arranged between the first part 12a and the second part 12b. The heating component 16 may be made of metal. Additionally, or alternatively, the heating component 16 may have a tensile strength above 0.20 GPa.

The arrangement 10 further comprises an electric power device 18 electrically connectable to the heating component 16 for electric resistance welding of the comparative layer structure 14. The electric connection between the electric power device 18 and the heating component 16 may be established and interrupted via a switch 20.

For welding, an electric current is caused to flow through the heating component 16. The electric current may be controlled by monitoring the flow by means of an ammeter 22 and/or a voltmeter 24. The electric current leads to heating of the heating component 16. The heating leads to melting of the first part 12a, the second part 12b, and/or the heating component 16 along a weld joint surface 26 of the layer structure 14. During welding, a pressure P may be applied onto the comparative layer structure 14 orthogonal and/or normal to the weld joint surface 26. In this way, the first part 12a and the second part 12b may be joined together.

In general, during electric resistance welding, shunt or short circuits may arise depending on the two parts 12, 12a, 12b to be joined. Particularly, if at least one of the parts 12, 12a, 12b is electrically conductive, shunt or short circuits via the electrically conductive part 12, 12a, 12b may lead to leakage of a portion of the electric current flowing through the heating component 16. This may also influence the quality of the weld joint. An idea of preferred embodiments of the invention is to avoid shunt or short circuits and to improve the quality of the weld joint.

FIG. 2 shows an arrangement 10 for joining the two or more parts 12, 12a, 12b by means of electric resistance welding according to an embodiment of the invention.

In the embodiment as shown in FIG. 2, the first part 12a and the second part 12b are electrically conductive. However, the invention also comprises embodiments with only one of the first part 12a and the second part 12b being electrically conductive.

The arrangement 10 includes the features of the comparative arrangement 10 as shown in FIG. 1. Additionally, the layer structure 14 includes two electrically insulating components 28. A first electrically insulating component 28a is arranged between the heating component 16 and the first part 12a. A second electrically insulating component 26b is arranged between the heating component 16 and the second part 12b.

The electrically insulating components 28a, 28b comprise each one or more basalt fibers 30. The insulating components 28 may comprise basalt fibers 30 in form of a basalt fiber-based textile, a basalt fiber-based fabric, a basalt fiber-based mesh, a basalt fiber-based mat, and/or a basalt fiber-based fleece. The insulating components 28 may also comprise a composite, preferably a basalt fiber-reinforced material, such as a basalt fiber-reinforced polymer and/or thermoplastic.

The following Table I shows a comparison of properties of basalt fibers 30 with fibers of other materials (see: Chowdhury, I. R.; Pemberton, R.; Summerscales, J. Developments and Industrial Applications of Basalt Fibre Reinforced Composite Materials. J. Compos. Sci. 2022, 6, 367. https://doi.org/10.3390/jcs6120367.):

TABLE I

| | Fiber material | | | | |
|---|---|---|---|---|---|
| Parameter | Basalt | Carbon | E-glass | S-glass | Aramid |
| $Density in \frac{g}{c {m}^{3}}$ | 2.80-3.00 | 1.75-1.90 | 2.50-2.60 | 2.46-2.50 | 1.44 |
| Tensile strength in | 3000-4840 | 3500-6000 | 3100-3800 | 4590-4830 | 2900-3400 |
| MPa | | | | | |
| $Specific strength in \frac{N \cdot m}{g}$ | 1000-1714 | 1842-3429 | 1192-1520 | 1836-1963 | 2014-2361 |
| Young’s modulus in GPa | 79.3-93.1 | 230-600 | 72.5-75.5 | 88.0-91.0 | 70.0-112 |
| Elongation at break % | 3.1 | 1.5-2.0 | 4.7 | 5.6 | 2.8-3.6 |
| Working | −200 to 700 | −50.0 to 700 | −50.0 to 380 | −50.0 to 300 | 196 to 427 |
| temperature in ° C. | | | | | |
| $Price in \frac{U S D}{k g}$ | 2.5-3.5 | 30 | 0.75-1.2 | 5.0-7.0 | 25 |

The following Table II shows a selection of thermal properties of basalt fibers 30 (see: Chowdhury, I. R.; Pemberton, R.; Summerscales, J. Developments and Industrial Applications of Basalt Fibre Reinforced Composite Materials. J. Compos. Sci. 2022, 6, 367. https://doi.org/10.3390/jcs6120367; and http://www.minsocam.org/msa/collectors_corner/arc/tempmagmas.htm):

TABLE II

| Parameter | Value |
|---|---|
| Melting temperature in ° C. | 984-1260 |
| Working temperature range in ° C. | −200 to 700 |
| $Thermal conductivity coeficient in \frac{W}{m \cdot K}$ | 0.031-0.038 |
| $Linear thermal expansion coefficient in \frac{1}{1 {0}^{6} K}$ | 8.00 |
| $Specific heat capacity in \frac{J}{kg \cdot K}$ | 0.340-1.26 |

The inventors found that some properties of basalt fibers 30 according to Table I and Table II and as mentioned herein are advantageous for a method for joining the two or more parts 12 by means of electric resistance welding. Advantages of basalt fibers 30 may be the high Young's modulus in the range from 90 to 120 GPa, the large working temperature range from −260 to +650° C., favorable properties at changing temperatures, good corrosion properties as well as a very good vibration resistance. Thus, basalt fibers 30 may be used in aircraft construction, for example, to produce bonded aluminum laminates.

The inventors further found that basalt fibers 30 that may be used for electric resistance welding, preferably comprise the one, several, or all of the following components:

TABLE III

| Component | % w/w | more preferred % w/w |
|---|---|---|
| SiO₂ | 35-55 | 47-50 |
| TiO₂ | 0-5 | 1-2 |
| Al₂O₃ | 10-25 | 15-18 |
| Fe₂O₃, FeO | 7-20 | 11-14 |
| MgO | 3-10 | 5-7 |
| CaO | 5-20 | 6-12 |
| N₂O | 0-5 | 2-3 |
| K₂O | 0-10 | 2-7 |

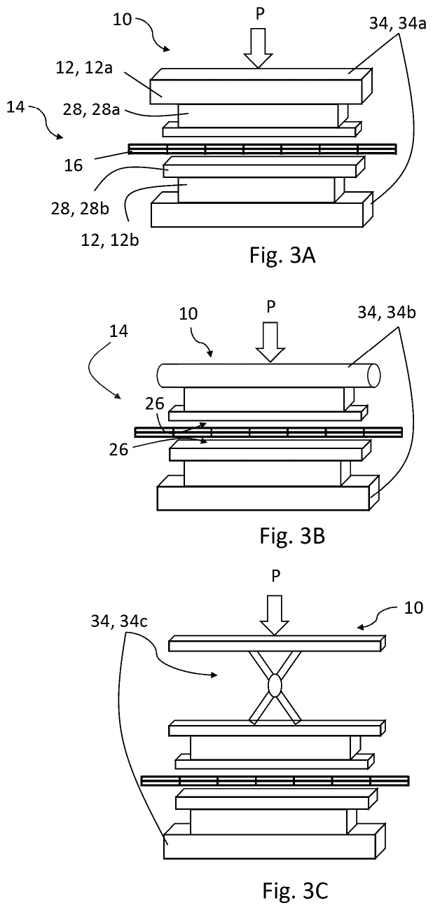

FIG. 3 shows the arrangement 10 according to further embodiments of the invention.

The arrangements 10 as shown in FIGS. 3A, 3B and 3C comprise each a pressure application device 34 for applying the pressure P onto the layer structure 14 orthogonal and/or normal to the weld joint surface 26.

In FIG. 3A, the pressure application device 34 comprises a stamping device 34a for applying a stamping pressure onto the layer structure 14. In FIG. 3B, the pressure application device 34 comprises an air cushion device 34b for applying an air cushion pressure onto the layer structure 14. In FIG. 3C, the pressure application device 34 comprises a bent lever device 34c for applying a bent lever pressure onto the layer structure 14.

The invention also provides the method for joining the two or more parts 12 by means of electric resistance welding. The invention further provides a welded layer structure joining two or more parts 12, wherein the welded layer structure is obtainable by the method.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 arrangement
12 part
12a first part
12b second part
14 layer structure
16 heating component
18 electric power device
20 switch
22 ammeter
24 voltmeter
26 weld joint surface
28 insulating component
28a first insulating component
28b second insulating component
30 basalt fiber
34 pressure application device
34a stamping device
34b air cushion device
34c bent lever device
P pressure

1. A method for joining two parts by means of electric resistance welding, the method comprising:
a) providing a layer structure for electric resistance welding, the layer structure including:
two parts to be joined, wherein at least one of the two parts is electrically conductive,
an electrically conductive heating component arranged between the two parts, and
an electrically insulating component arranged between the heating component and the at least one electrically conductive part, the insulating component comprising one or more basalt fibers; and
b) causing an electric current to flow through the heating component for electric resistance welding of the layer structure along a weld joint surface of the layer structure and thus joining the two parts.

2. The method according to claim 1, further comprising:
c) applying a pressure onto the layer structure orthogonal, normal or both orthogonal and normal to the weld joint surface during electric resistance welding.

3. The method according to claim 1, further comprising one or more of the following:
d1) Young's modulus of the one or more basalt fibers is above 50 GPa,
d2) Young's modulus of the one or more basalt fibers is in a range from 90 to 120 GPa;
d3) the one or more basalt fibers comprise 35-55% w/w SiO₂,
d4) the one or more basalt fibers comprise 47-50% w/w SiO₂;
d5) the one or more basalt fibers comprise 10-25% w/w Al₂O₃,
d6) the one or more basalt fibers comprise 15-18% w/w Al₂O₃;
d7) the one or more basalt fibers comprise 3-10% w/w MgO,
d8) the one or more basalt fibers comprise 5-7% w/w MgO; and
d9) an elongation at break of the one or more basalt fibers is in a range from 2 to 5%.

4. The method according to claim 1, wherein the heating component is made of metal, has a tensile strength above 0.20 GPa, or both is made of metal and has a tensile strength above 0.20 GPa.

5. The method according to claim 1, wherein the insulating component comprises one or more of a basalt fiber-based textile, a basalt fiber-based fabric, a basalt fiber-based mesh, a basalt fiber-based mat, and a basalt fiber-based fleece.

6. The method according to claim 1, wherein the insulating component comprises a composite.

7. The method according to claim 6, wherein the composite comprises a basalt fiber-reinforced material.

8. The method according to claim 6, wherein the composite comprises a basalt fiber-reinforced polymer.

9. The method according to claim 6, wherein the composite comprises a basalt fiber-reinforced thermoplastic.

10. The method according to claim 9, wherein the composite comprises a polymer.

11. The method according to claim 6, wherein:
e1) the one or more basalt fibers comprise 35-75% vol. of the composite;
e2) the one or more basalt fibers are arranged in parallel in a matrix of the composite, or
e3) the one or more basalt fibers comprise 35-75% vol. of the composite and the one or more basalt fibers are arranged in parallel in a matrix of the composite.

12. The method according to claim 1, wherein at least one of the one or more basalt fibers comprise a composite.

13. The method according to claim 12, wherein the composite comprises a fiber-reinforced material.

14. The method according to claim 13, wherein the fiber-reinforced material comprises at least one of a carbon, glass, basalt, and aramid fiber-reinforced material, or a combination of more than one of the carbon, glass, basalt, and aramid fiber-reinforced materials.

15. The method according to claim 14, wherein the fiber-reinforced material comprises a polymer.

16. The method according to claim 14, wherein the fiber-reinforced material comprises a thermoplastic.

17. The method according to claim 16, wherein the fiber-reinforced material comprises a polymer.

18. An arrangement for joining two parts by means of electric resistance welding, the arrangement comprising a layer structure for electric resistance welding, the layer structure including:
two parts to be joined, wherein at least one of the two parts is electrically conductive,
an electrically conductive heating component arranged between the two parts, and
an electrically insulating component arranged between the heating component and the at least one electrically conductive part, the insulating component comprising one or more basalt fibers.

19. The arrangement according to claim 18, further comprising a pressure application device for applying a pressure onto the layer structure orthogonal, normal or both orthogonal and normal to a weld joint surface of the layer structure.

20. The arrangement according to claim 18, further comprising an electric power device electrically connectable to a welding component for electric resistance welding of the layer structure.
